(19) United States
(12) Patent Application Publication
(10) Pub. No.: US 2017/0036169 A1
(43) Pub. Date: Feb. 9, 2017

(54) ASYMMETRIC POLY(PHENYLENE ETHER) CO-POLYMER MEMBRANE, SEPARATION MODULE THEREOF AND METHODS OF MAKING

(71) Applicant: SABIC GLOBAL TECHNOLOGIES B.V., Bergen op Zoom (NL)

(72) Inventors: Albin Peter Berzinis, Delmar, NY (US); Rachel Elizabeth Halbfinger, Glenville (US); Matias Bikel, Bergen op Zoom (NL); Pooja Bajaj, Schenectady, NY (US)

(73) Assignee: Sabic Global Technologies B.V., Bergen Op Zoom (NL)

(21) Appl. No.: 15/303,058

(22) PCT Filed: Apr. 30, 2015
(86) PCT No.: PCT/US2015/028537

§ 371 Date: Oct. 10, 2016

Related U.S. Application Data
(60) Provisional application No. 61/987,168, filed on May 1, 2014.

(51) Int. Cl. B01D 61/14; B01D 69/08; B01D 71/76; B01D 69/06; B01D 71/52; B01D 71/68; B01D 67/00; B01D 69/02

(52) U.S. Cl. CPC B01D 61/145; B01D 67/0009; B01D 67/0095; B01D 69/085; B01D 69/088; B01D 69/02; B01D 69/06; B01D 71/52; B01D 71/68; B01D 71/76; B01D 2325/34; B01D 2325/24; B01D 2325/36; B01D 2325/022

(57) ABSTRACT

A porous membrane made from a poly(phenylene ether) copolymer has at least one of: a molecular weight cut off of less than 40 kilodaltons or a surface pore size of 0.001 to 0.1 micrometers. The porous membrane is made by dissolving the poly(phenylene ether) copolymer in a water-miscible polar aprotic solvent to form a porous membrane-forming composition; and phase-inverting the porous asymmetric membrane forming-composition in a first non-solvent composition to form the porous membrane. The porous membrane can be in the form of a sheet or a hollow fiber, and can be fabricated into separation modules.

### BACKGROUND OF THE INVENTION

Ultrafiltration is a membrane separation process whereby a feed stock containing a solute, which has molecular or colloidal dimensions which are significantly greater than the molecular dimensions of its solvent, is depleted of the solute by being contacted with the membrane at such pressure that the solvent permeates the membrane and the solute is retained. This results in a permeate fraction which is solute depleted and a retentate fraction which is solute enriched. In ultrafiltration, and similarly nanofiltration and microfiltration, pressure in excess of the osmotic pressure can be used to force the solvent through the membrane. Reverse osmosis for drinking water production, the production of milk protein concentrate for cheese production, and enzyme recovery are examples.

A commercially viable separation membrane combines high selectivity, high permeation flux or throughput, and a long service life. Permeation flux is a measure of volumetric permeate flow through a membrane. The higher the permeation flux, the smaller the membrane area required to treat a given volume of process fluid. Separation factor is a measure of membrane selectivity. Separation factor is the ratio of the flux of the permeate across the membrane to the flux of the process stream. Since selectivity can be inversely proportional to flux, it is desirable to increase the selectivity without adversely affecting flux. It is also desirable to have separation membranes with long service lives under harsh conditions, for example high temperatures and exposure to corrosive reagents, so that replacement costs are minimized. A large number of materials have been investigated for use in separation membranes for reverse osmosis.

Poly(phenylene ether)s are a class of plastics having excellent water resistance, thermal resistance, and dimensional stability. They retain their mechanical strength in hot, and/or wet environments. Therefore they can be used for the fabrication of porous membranes useful in various separation processes. For example, poly(phenylene ether)s can be used in processes that require repeated cleaning with hot water or steam sterilization. Nonetheless, there remains a need for a membrane having improved filtration properties, including materials that will improve selectivity without adversely affecting permeation flux.

### BRIEF DESCRIPTION OF THE INVENTION

A porous membrane comprises, consists essentially of, or consists of a poly(phenylene ether) copolymer, wherein the porous membrane has at least one of a molecular weight cut off of less than 40 kilodaltons and a surface pore size of 0.001 to 0.1 micrometers. A method of making the porous membrane comprises: dissolving the poly(phenylene ether) copolymer in a water-miscible polar aprotic solvent to form a porous membrane-forming composition; and phase-inverting the porous asymmetric membrane forming-composition in a first non-solvent composition to form the porous membrane. A porous membrane is made by the method, and the porous membrane can be fabricated into a separation module.

A method of making a hollow fiber by coextrusion through a spinneret comprising an annulus and a bore, wherein the method comprises coextruding: a membrane-forming composition comprising a poly(phenylene ether) copolymer, dissolved in a water-miscible polar aprotic solvent through the annulus, and a first non-solvent composition comprising water, a water-miscible polar aprotic solvent, or a combination comprising at least one of the foregoing, through the bore, into a second non-solvent composition comprising water, a water-miscible polar aprotic solvent, or a combination comprising at least one of the foregoing, to form the hollow fiber. A hollow fiber is made by the method, and can be fabricated into a separation module.

### BRIEF DESCRIPTION OF THE DRAWINGS

Referring now to the drawings,

FIG. 1 depicts scanning electron microscopy (SEM) images of the porous asymmetric membrane surfaces and cross-sections of Comparative Example 1 and Example 5. The images, clockwise from the upper left corner are of the surface of Comparative Example 1, the surface of Example 5, cross-sections of Example 5, and cross-sections of Comparative Example 1.

FIG. 2 depicts scanning electron microscopy (SEM) images of the porous asymmetric membrane surfaces and cross-sections of Examples 6-8. The top images are of the membrane surfaces of Examples 6-8, and the bottom images are of membrane cross-sections of Examples 6-8.

FIG. 4 depicts SEM images of the asymmetric membranes of Examples 14-16, produced from the membrane-forming copolymers of Examples 11-13, respectively.

FIG. 5 depicts SEM images of the asymmetric membranes of Example 17 and Comparative Example 2.

FIG. 6 depicts a diagram of a laboratory scale, dry-wet immersion precipitation hollow fiber spinning apparatus.

FIG. 7 depicts laboratory-scale hollow fiber membrane modules.

FIG. 8 depicts hollow fiber filtration modules.

FIG. 9 depicts SEM images of the hollow fiber membranes of Comparative Example 4 and Example 13.

FIG. 10 depicts SEM images of PES fibers spun with and without glycerin.

### DETAILED DESCRIPTION OF THE INVENTION

The inventors hereof have discovered that a specific class of copolymers having two or more different types of poly(phenylene ether) repeat units is particularly useful in the manufacture of porous membranes for ultrafiltration. The poly(phenylene ether) copolymer is hydrophobic, and can be fabricated into both flat membranes and hollow fiber membranes.

The porous membrane comprises, consists essentially of, or consists of a poly(phenylene ether) copolymer, wherein the porous membrane has at least one of a molecular weight cut off of less than 40 kilodaltons and a surface pore size of 0.001 to 0.1 micrometers. In some embodiments, The poly(phenylene ether) copolymer comprises, consists essentially of, or consists of first and second repeat units having the structure:

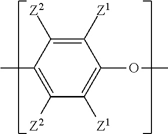

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy, wherein at least two carbon atoms separate the halogen and oxygen atoms, wherein each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy, wherein at least two carbon atoms separate the halogen and oxygen atoms, and wherein the first repeat units and second repeat units are not the same.

In some embodiments, the poly(phenylene ether) copolymer comprises: 99 to 20 mole percent, specifically 90 to 30 mole percent, and more specifically 80 to 50 mole percent repeat units derived from 2,6-dimethylphenol; and 1 to 80 mole percent, specifically 10 to 70 mole percent, and more specifically 20 to 50 mole percent repeat units derived from a second monohydric phenol having the structure

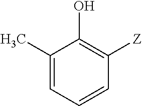

wherein Z is C₁-C₁₂ alkyl or cycloalkyl, or a monovalent radical having the structure

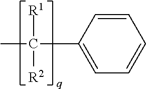

wherein q is 0 or 1, and R¹ and R² are independently hydrogen or C₁-C₆ alkyl; wherein all mole percents are based on the total moles of all repeat units.

In some embodiments, the poly(phenylene ether) copolymer comprises: 80 to 20 mole percent repeat units derived from 2,6-dimethylphenol; and 20 to 80 mole percent repeat units derived from the second monohydric phenol. In some embodiments, the second monohydric phenol comprises 2-methyl-6-phenylphenol. For example, the poly(phenylene ether) copolymer can comprise 20 to 80 mole percent of repeat units derived from 2-methyl-6-phenylphenol and 80 to 20 mole percent repeat units derived from 2,6-dimethylphenol. The copolymer can also be a copolymer of 2,6-dimethylphenol and 2,3,6-trimethylphenol, or a terpolymer of 2,6-dimethylphenol and 2,6-trimethylphenol, and 2,3,6-trimethylphenol.

The hydrophobic polymer can be a poly(phenylene ether) copolymer having an intrinsic viscosity greater than or equal to 0.7, 0.8, 0.9, 1.0, or 1.1 deciliters per gram, and less than or equal to 1.5, 1.4, or 1.3 deciliters per gram, when measured in chloroform at 25° C. In some embodiments, the intrinsic viscosity is 1.1 to 1.3 deciliters per gram.

In some embodiments, the poly(phenylene ether) copolymer has a weight average molecular weight of 100,000 to 500,000 daltons (Da), as measured by gel permeation chromatography against polystyrene standards. Within this range, the weight average molecular weight can be greater than or equal to 150,000 or 200,000 Da and less than or equal to 400,000, 350,000, or 300,000 Da. In some embodiments, the weight average molecular weight is 100,000 to 400,000 Da, specifically 200,000 to 300,000 Da. The poly(phenylene ether) copolymer can have a polydispersity (ratio of weight average molecular weight to number average molecular weight of 3 to 12. Within this range, the polydispersity can be greater than or equal to 4 or 5 and less than or equal to 10, 9, or 8.

In some embodiments, the poly(phenylene ether) copolymer has a solubility of 50 to 400 grams per kilogram in N-methyl-2-pyrrolidone at 25° C. in N-methyl-2-pyrrolidone, based on the combined weight of the poly(phenylene ether) copolymer and N-methyl-2-pyrrolidone. Within this range, the solubility can be greater than or equal to 100, 120, 140, or 160 grams per kilogram, and less than or equal to 300, 250, 200, or 180 grams per kilogram at 25° C. Advantageously, the use hydrophobic copolymers having an intrinsic viscosity of 0.7 to 1.5 deciliters per gram and a solubility of 50 to 400 grams per kilogram at 25° C. results in membrane-forming compositions with solution concentrations and viscosities that provides good control over the phase inversion step of membrane formation. Advantageously, a copolymer having an intrinsic viscosity of 0.7 to 1.5 deciliters per gram and a solubility of 50 to 400 grams per kilogram provides membrane-forming compositions conducive to the formation of suitable porous membranes in the absence of hydrophilic polymers, for example, poly(N-vinylpyrrolidone), which can serve as a viscosity modifier.

Porous membranes can be fabricated from poly(2,6-dimethyl-1,4-phenylene ether), polyethersulfone, polysulfone, or polyphenylsulfone. Thus the porous membrane can comprise 20 to 99 weight percent of the poly(phenylene ether) copolymer and 1 to 80 weight percent of poly(2,6-dimethyl-1,4-phenylene ether), polyethersulfone, polysulfone, polyphenylsulfone, or a combination comprising at least one of the foregoing, based on the total weight of the porous membrane.

The porous membrane has many advantageous properties. The poly(phenylene ether) copolymers have hydrophobic surfaces, as measured, for example, by water contact angle. Because of the hydrophobic surface, the porous membranes can be used for purification of a variety of aqueous and non-aqueous streams and gaseous streams, and are resistant to fouling. Advantageously, the copolymer has a desirable pore size distribution, membrane selectivity, and permeation flux. The poly(phenylene ether) copolymer further resists extraction by water. Advantageously, this results in reduced loss of poly(phenylene ether) copolymer upon contact with process streams in end-use applications, and especially during cleaning.

The porous membrane can be fabricated from a porous membrane-forming composition. In some embodiments, the porous membrane-forming composition for making the porous membrane comprises: a poly(phenylene ether) copolymer comprising the first and second repeat units; and a water-miscible polar aprotic solvent, wherein the poly(phenylene ether) copolymer is dissolved in the water-miscible polar aprotic solvent. The description of the porous membrane herein is also applicable to the membrane-forming composition. For example, the poly(phenylene ether) copolymer in the membrane-forming composition can comprise 80 to 20 mole percent repeat units derived from 2,6-dimethylphenol; and 20 to 80 mole percent repeat units derived from 2-methyl-6-phenylphenol.

The porous membranes can be prepared from the porous membrane-forming composition. Thus, a method of making the porous membrane comprises dissolving the poly(phenylene ether) copolymer in a water-miscible polar aprotic solvent to form a porous membrane-forming composition; and phase-inverting the porous asymmetric membrane forming-composition in a first non-solvent composition to form the porous membrane.

Hydrophilic copolymers have been added to membrane-forming compositions to impart a viscosity to the membrane-forming compositions that is conducive to the formation of a porous membrane useful for purification of aqueous streams. However, hydrophilic polymers, when present in the porous asymmetric membrane, are prone to extraction in the phase inversion and washing steps of membrane fabrication. Moreover the hydrophilic polymer can be leached out of the membrane in the end-use application-membrane treatment of aqueous streams. For example, polyethersulfone can be blended with poly(N-vinylpyrrolidone), and the two polymers can be co-precipitated from solution to form a membrane. Excess poly(N-vinylpyrrolidone) must be washed off of the membrane with water, which results in a waste of valuable material, and which produces an aqueous waste comprising the excess poly(N-vinylpyrrolidone).

Advantageously, the porous membranes are useful for purification of aqueous or non-aqueous streams, and are produced in the absence of hydrophilic or amphiphilic polymers, or any other viscosity modifier. Thus, in some embodiments, hydrophilic and amphiphilic polymers are absent from the membrane-forming composition and the first non-solvent composition. An amphiphilic polymer is defined herein as a polymer that has both hydrophilic (water-loving, polar) and hydrophobic (water-hating, non-polar) properties For example, the amphiphilic polymer can be a block copolymer comprising a hydrophobic block and a hydrophilic block or graft. The hydrophilic and amphiphilic polymers absent from the membrane-forming composition and the first non-solvent composition can comprise, for example, poly(vinyl pyrrolidone), poly(oxazoline), poly(ethylene glycol), poly(propylene glycol), a poly(ethylene glycol) monoether or monoester, a poly(propylene glycol) monoether or monoester, a block copolymer of poly(ethylene oxide) and poly(propylene oxide), polystyrene-graft-poly(ethylene glycol), polystyrene-graft-poly(propylene glycol), polysorbate, cellulose acetate, or a combination comprising at least one of the foregoing.

In some embodiments, the method further comprises washing the porous membrane in a second non-solvent composition. This step serves to rinse any residual water-miscible polar aprotic solvent from the membrane. The first and second non-solvent compositions can be the same or different, and can comprise water, or a mixture of water and a water-miscible polar aprotic solvent. In some embodiments the first and second non-solvents are independently selected from water, and a mixture of water and N-methyl-2-pyrrolidone mixture. In some embodiments, the first and second non-solvents are both water. The water can be deionized. In some embodiments, the method further comprises drying the porous membrane, which serves to remove any residual first and second non-solvent composition, for example water and N-methyl-2-pyrrolidone.

The water-miscible polar aprotic solvent is one that is polar, but does not have any ionizable hydrogen atoms at a pH of 1 to 14. The water-miscible polar aprotic solvent can be, for example, N-methyl-2-pyrrolidone (NMP), N,N-dimethylformamide (DMF), N,N-dimethylacetamide (DMAC), N-ethyl-2-pyrrolidone, dimethyl sulfoxide (DMSO), dimethyl sulfone, sulfolane, butyrolactone; and combinations comprising at least one of the foregoing. In some embodiments, the water-miscible polar aprotic solvent comprises N-methyl-2-pyrrolidone.

The first non-solvent composition serves as a coagulation, or phase inversion, bath for the porous membrane-forming composition. The porous membrane is formed by contacting the membrane-forming composition with the first non-solvent composition. The poly(phenylene ether) copolymer, which is near its gel point in the membrane-forming composition, coagulates, or precipitates as a film or hollow fiber depending upon the specific method used. The second non-solvent composition serves to rinse residual water-miscible solvent, if present, from the membrane. The first and second non-solvent compositions can be the same or different, and can comprise water, or a mixture of water and a water-miscible polar aprotic solvent. In some embodiments the first and second non-solvents are independently selected from water, and a mixture of water and N-methyl-2-pyrrolidone. In some embodiments, the first and second non-solvent compositions are both water. The water can be deionized.

In some embodiments, the first non-solvent composition comprises 10 to 100 weight percent water and 0 to 90 weight percent N-methyl-2-pyrrolidone, based on the total weight of the first non-solvent composition. Within this range, the first non-solvent composition can comprise 10 to 90 weight percent, specifically 10 to 80 weight percent, water and 10 to 90 weight percent, specifically 20 to 90 weight percent, N-methyl-2-pyrrolidone. In some embodiments, the first non-solvent composition comprises about 70 weight percent water and about 30 weight percent N-methyl-2-pyrrolidone.

Any of several techniques for the phase inversion step of porous membrane formation can be used. For example, the phase inversion step can be a dry-phase separation method in which the dissolved copolymer is precipitated by evaporation of a sufficient amount of solvent mixture to form the membrane. The phase inversion step can also be a wet-phase separation method in which the dissolved copolymer is precipitated by immersion in the first non-solvent to form the membrane. The phase inversion step can be a dry-wet phase separation method, which is a combination of the dry-phase and the wet-phase methods. The phase inversion step can be a thermally-induced separation method in which the dissolved copolymer is precipitated or coagulated by controlled cooling to form the membrane. The membrane, once formed, can be subjected to membrane conditioning or pretreatment, prior to its end-use. The conditioning or pretreatment can be thermal annealing to relieve stresses or pre-equilibration in the expected feed stream.

The description of the porous membrane herein is also applicable to the method of forming the porous membrane. For example the poly(phenylene ether) copolymer used in the method to form the porous membrane can comprise 80 to 20 mole percent repeat units derived from 2,6-dimethylphenol; and 20 to 80 mole percent repeat units derived from 2-methyl-6-phenylphenol.

A porous membrane is made by the method described herein, including variations. In some embodiments, the porous membrane is made by a method in which hydrophilic and amphiphilic polymers are absent from the membrane-forming composition and the first non-solvent composition.

The method is applicable to hollow fiber spinning. Thus in some embodiments, a method of making a hollow fiber by coextrusion through a spinneret comprising an annulus and a bore, comprises coextruding: a membrane-forming composition comprising a poly(phenylene ether) copolymer, dissolved in a water-miscible polar aprotic solvent through the annulus, and a first non-solvent composition comprising water, a water-miscible polar aprotic solvent, or a combination comprising at least one of the foregoing, through the bore, into a second non-solvent composition comprising water, a water-miscible polar aprotic solvent, or a combination comprising at least one of the foregoing, to form the hollow fiber. In some embodiments of the method of making a hollow fiber, hydrophilic and amphiphilic polymers are absent from the membrane-forming composition and the first non-solvent composition.

In some embodiments, a hollow fiber is made by the method, which comprises coextruding a membrane-forming composition comprising a poly(phenylene ether) copolymer dissolved in a water-miscible polar aprotic solvent through the annulus, and a first non-solvent composition comprising water, a water-miscible polar aprotic solvent, or a combination comprising at least one of the foregoing, through the bore, into a second non-solvent composition comprising water, a water-miscible polar aprotic solvent, or a combination comprising at least one of the foregoing, to form the hollow fiber. In some embodiments the hollow fiber is made by the method in which hydrophilic and amphiphilic polymers are absent from the membrane-forming composition and the first non-solvent composition.

The hollow fiber made by the method can be fabricated into separation modules designed for the purification of wastewater and various industrial process streams, including aqueous and non-aqueous process streams. Thus in some embodiments, a separation module comprises the hollow fiber made by the method, comprising coextruding a membrane-forming composition comprising a poly(phenylene ether) copolymer dissolved in a water-miscible polar aprotic solvent through the annulus, and a first non-solvent composition comprising water, a water-miscible polar aprotic solvent, or a combination comprising at least one of the foregoing, through the bore, into a second non-solvent composition comprising water, a water-miscible polar aprotic solvent, or a combination comprising at least one of the foregoing, to form the hollow fiber.

The poly(phenylene ether) copolymer can be used to fabricate porous membranes designed for the purification of wastewater and various industrial process streams, including aqueous and non-aqueous process streams. The porous membrane comprises, consists essentially of, or consists of, the poly(phenylene ether) copolymer. The porous membranes disclosed herein can be fabricated into a variety of shapes. Thus, in some embodiments, the porous membrane is in a sheet, disc, spiral wound, plate and frame, hollow fiber, capillary, or tube configuration.

In some embodiments, the porous membrane is a porous hollow fiber. The diameter of the hollow fiber can be 30 to 100 nanometers. Within this range, the diameter can be less than or equal to 80, 60, 40, or 35 nanometers. In another embodiment the diameter can be 50 to 10,000 micrometers (μm), specifically 100 to 5000 μm. In some embodiments, the membrane can comprise a non-porous surface layer to provide an asymmetric membrane, and the non-porous surface layer can be on the outside of the hollow fiber. A porous hollow fiber module can comprise bundles of porous hollow fibers. In some embodiments, the fiber bundle comprises 10 to 10,000 porous hollow fibers. The hollow fibers can be bundled longitudinally, potted in a curable resin on both ends, and encased in a pressure vessel to form the hollow fiber module. Hollow fiber modules can be mounted vertically or horizontally.

Depending upon porous asymmetric membrane surface pore size distribution and pore density, and the end-use, the separation module fabricated from the porous asymmetric membrane made by the method can be a media filtration module, a microfiltration module, an ultrafiltration module, a nanofiltration module, or a reverse osmosis module. The separation module fabricated from the porous asymmetric membrane made by the method can also be a membrane contactors module, a pervaporation module, a dialysis module, an osmosis module, an electrodialysis module, a membrane electrolysis module, an electrophoresis module, or a membrane distillation module. For media filtration, the surface pore size can be about 100 to about 1,000 micrometers. For microfiltration, the surface pore size can be about 0.03 to about 10 micrometers. For ultrafiltration, the surface pore size can be about 0.002 to 0.1 micrometers. For nanofiltration, the surface pore size can be about 0.001 to about 0.002 micrometers. For reverse osmosis, the surface pore size can be about 0.0001 to 0.001 micrometers. The porous asymmetric membranes are surprisingly well suited for ultrafiltration and nanofiltration. In some embodiments, the porous asymmetric membrane has a surface pore size of 0.001 to 0.05 micrometers (am), specifically 0.005 to 0.01 m.

The molecular weight cut off (MWCO) of a membrane is the lowest molecular weight solute in which 90 weight percent (wt %) or greater of the solute is retained by the membrane. The porous asymmetric membranes made by the method can have a MWCO of 500 to 40,000 daltons (Da), specifically 1,000 to 10,000 Da, more specifically 2,000 to 8,000 Da, or still more specifically 3,000 to 7,000 Da. Furthermore, any of the foregoing MWCO ranges can be present in combination with a desirable permeate flux, such as clean water permeate flux (CWF). For example, the permeate flux can be 1 to 200, specifically 2 to 100, more specifically 4 to 50 L/(h·m²·bar), wherein “L” is liters and “m²” is square meters. The porous asymmetric membranes made by the method can also provide a CWF of about 10 to about 80 L/(h·m²·bar), about 20 to about 80 L/(h·m²·bar), or about 40 to about 60 L/(h·m²·bar). In some embodiments, the porous membrane has at least one of: a surface pore size of 0.001 to 0.1 micrometers, a molecular weight cut off of less than 40 kilodaltons when analyzed using a Reynolds number of 3000, and a permeate flux of 1 to 200 L/(h·m²·bar).

Flux across the membrane is driven by the osmotic or absolute pressure differential across the membrane, referred to herein as the trans-membrane pressure (TMP). The trans-membrane pressure can be 1 to 500 kilopascals (kPa), specifically 2 to 400 kPa, and more specifically 4 to 300 kPa.

The porous asymmetric membranes made by the method are useful for treatment of a variety of aqueous streams. Depending upon surface pore size distribution and pore density, and the configuration of the porous asymmetric membrane, the porous asymmetric membrane can be used to remove one or more of the following contaminants from water: suspended matter, particulate matter, sands, silt, clays, cysts, algae, microorganisms, bacteria, viruses, colloidal matter, synthetic and naturally occurring macromolecules, dissolved organic compounds, and salts. Thus, separation modules fabricated from the porous asymmetric membranes made by the method can be used in wastewater treatment, water purification, food processing, and in the dairy, biotechnology, pharmaceutical, and healthcare industries.

The porous asymmetric membranes made by the method, and separation modules fabricated from the porous asymmetric membranes made by the method, can advantageously be used in medical, pharmaceutical, biotechnological, or food processes, for example the removal of salts and/or low molecular weight organic impurities from aqueous streams by ultrafiltration, which results in increased concentration of a material having a molecular weight above the cut-off of the porous asymmetric membrane in an aqueous stream. The aqueous stream can be human blood, animal blood, lymph fluids, microbial or cellular suspensions, for example suspensions of bacteria, alga, plant cells, or viruses. Specific medical applications include the concentration and purification of peptides in blood plasma; hemofiltration; hemodialysis; hemodiafiltration; and renal dialysis. Other applications include enzyme recovery and desalting of proteins. Specific food applications include ultrafiltration of meat products and by-products, plant extracts, suspensions of algae or fungi, vegetable food and beverages containing particles such as pulp, and the production of milk protein concentrate for the production of cheese. Other applications include downstream processing of fermentation broths; concentration of protein in whole egg or egg white with simultaneous removal of salts and sugars; and concentration of gelling agents and thickeners, for example agar, carrageenan, pectin, or gelatin. Since a separation module fabricated from the porous asymmetric membrane made by the process is useful for a wide variety of aqueous fluid separation applications in many different fields, it may be applicable to other fluid separation problems not expressly disclosed herein as well.

Separation modules fabricated from the porous asymmetric membrane made by the method can be used for liver dialysis or hemodialysis; for separation of polysaccharides, wherein separation comprises contacting a mixture of sugars, such as dextrose, glucose and fructose, with the asymmetric porous membrane to provide a product stream enriched in a desired sugar; for protein or enzyme recovery; for the production of purified water, e.g., drinking water; for pretreatment of water in desalination systems, where the separation module can be used to remove contaminants, including biological contaminants such as bacteria or protozoa, or organic chemical contaminants such as polychlorinated biphenyls (PCBs), to produce a purified product stream; for oxygenation of blood, such as in an artificial lung device; or for wastewater treatment; or for membrane distillation.

The invention includes at least the following embodiments.

### Embodiment 1

A porous membrane, wherein the porous membrane comprises, consists essentially of, or consists of a poly(phenylene ether) copolymer, wherein the porous membrane has at least one of a molecular weight cut off of less than 40 kilodaltons and a surface pore size of 0.001 to 0.1 micrometers.

### Embodiment 2

The porous membrane of claim 1, wherein the poly(phenylene ether) copolymer comprises, consists essentially of, or consists of first and second repeat units having the structure:

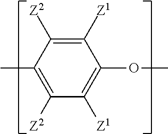

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy, wherein at least two carbon atoms separate the halogen and oxygen atoms, wherein each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy, wherein at least two carbon atoms separate the halogen and oxygen atoms, and wherein the first repeat units and second repeat units are not the same.

### Embodiment 3

The porous membrane of embodiment 1 or 2, wherein the poly(phenylene ether) copolymer comprises:

99 to 20 mole percent repeat units derived from 2,6-dimethylphenol; and 1 to 80 mole percent repeat units derived from a second monohydric phenol having the structure

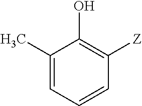

wherein Z is C₁-C₁₂ alkyl or cycloalkyl, or a monovalent radical having the structure

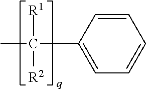

wherein q is 0 or 1, and R¹ and R² are independently hydrogen or C₁-C₆ alkyl; wherein all mole percents are based on the total moles of all repeat units.

### Embodiment 4

The porous membrane of embodiment 3, wherein the copolymer comprises: 80 to 20 mole percent repeat units derived from 2,6-dimethylphenol; and 20 to 80 mole percent repeat units derived from the second monohydric phenol.

### Embodiment 5

The porous membrane of embodiment 3 or 4, wherein the second monohydric phenol is 2-methyl-6-phenylphenol.

### Embodiment 6

The porous membrane of any of embodiments 1-5, wherein the poly(phenylene ether) copolymer has an intrinsic viscosity of 0.7 to 1.5 deciliters per gram, when measured in chloroform at 25° C.

### Embodiment 7

The porous membrane of any of embodiments 1-6, wherein the poly(phenylene ether) copolymer has a weight average molecular weight of 100,000 to 500,000 daltons, as measured in chloroform by gel permeation chromatography against polystyrene standards.

### Embodiment 8

The porous membrane of any of embodiments 1-7, wherein the poly(phenylene ether) copolymer has a solubility of 50 to 400 grams per kilogram in N-methyl-2-pyrrolidone at 25° C. in, based on the combined weight of the poly(phenylene ether) copolymer and N-methyl-2-pyrrolidone.

### Embodiment 9

The porous membrane of any of embodiments 1-8, comprising 20 to 99 weight percent of the poly(phenylene ether) copolymer and 1 to 80 weight percent of poly(2,6-dimethyl-1,4-phenylene ether), polyethersulfone, polysulfone, polyphenylsulfone, or a combination comprising at least one of the foregoing, based on the total weight of the porous membrane.

### Embodiment 10

A porous membrane-forming composition for making the porous membrane of any of embodiments 1-8, comprising: a poly(phenylene ether) copolymer comprising the first and second repeat units; and a water-miscible polar aprotic solvent, wherein the poly(phenylene ether) copolymer is dissolved in the water-miscible polar aprotic solvent.

### Embodiment 11

A method of making the porous membrane of any of embodiments 1-8, comprising: dissolving the poly(phenylene ether) copolymer in a water-miscible polar aprotic solvent to form a porous membrane-forming composition; and phase-inverting the porous asymmetric membrane forming-composition in a first non-solvent composition to form the porous membrane.

### Embodiment 12

The method of embodiment 11, wherein hydrophilic and amphiphilic polymers are absent from the membrane-forming composition and the first non-solvent composition.

### Embodiment 13

The method of embodiment 11 or 12, further comprising washing the porous membrane in a second non-solvent composition.

### Embodiment 14

The method of any of embodiments 11-13, further comprising drying the porous membrane.

### Embodiment 15

A porous membrane made by the method of any of embodiments 11-14.

### Embodiment 16

A method of making a hollow fiber by coextrusion through a spinneret comprising an annulus and a bore, wherein the method comprises coextruding: a membrane-forming composition comprising a poly(phenylene ether) copolymer, dissolved in a water-miscible polar aprotic solvent through the annulus, and a first non-solvent composition comprising water, a water-miscible polar aprotic solvent, or a combination comprising at least one of the foregoing, through the bore, into a second non-solvent composition comprising water, a water-miscible polar aprotic solvent, or a combination comprising at least one of the foregoing, to form the hollow fiber.

### Embodiment 17

The method of embodiment 16, wherein hydrophilic and amphiphilic polymers are absent from the membrane-forming composition and the first non-solvent composition.

### Embodiment 18

A separation module comprising the porous asymmetric membrane of any of embodiments 1-9.

### Embodiment 19

A hollow fiber made by the method of embodiment 16 or 17.

### Embodiment 20

A separation module comprising the hollow fiber of embodiment 19.

The invention is further illustrated by the following non-limiting examples.

### PREPARATIVE EXAMPLES

### Synthesis of MPP-DMP Copolymers

The copolymerizations were conducted in a bubbling polymerization reactor equipped with a stirrer, temperature control system, nitrogen padding, oxygen bubbling tube, and computerized control system. There were also feeding pot and pump for dosing reactants into the reactor.

TABLE 1
Materials

| Abbreviation | Chemical Name |
|---|---|
| DMP | 2,6-Dimethylphenol |
| MPP | 2-Methyl-6-phenylphenol |
| DBA | Di-n-butylamine |
| DBEDA | N,N′-Di-tert-butylethylenediamine |
| DMBA | N,N-Dimethylbutylamine |
| QUAT | Didecyldimethyl ammonium chloride |
| NTA | Nitrilotriacetic acid |
| CAT | Solution of Cu₂O in concentrated HBr, 6.5 wt. % Cu |
| NMP | N-Methyl-2-pyrrolidone, available from ThermoFisher. |
| 6020P | Polyphenylsulfone, available from BASF as |
| | ULTRASON ™ 6020P. |
| PVP K30 | Poly(vinyl pyrrolidone) having a K value of 26-35, |
| | calculated for a 1% aq. solution by the Finkentscher |
| | equation; and available from Aldrich. |
| PVP K90 | Poly(vinyl pyrrolidone) having a K value of 90-100, |
| | calculated for a 1% aq. solution by the Finkentscher |
| | equation; and available from Aldrich. |

### Preparative Example 1

### Preparation of MPP-DMP Copolymer with 50 Mole Percent MPP in 1.8-Liter Reactor

Toluene (622.88 grams), DBA (8.1097 grams), DMBA (30.71 grams), and 5.44 grams of a diamine mix consisting of 30 weight percent (wt. %) DBEDA, 7.5 weight percent QUAT, and the balance toluene, were charged to a bubbling polymerization reactor and stirred under a nitrogen atmosphere at 25° C. A mix of 6.27 grams HBr and 0.5215 grams Cu₂O was added. Oxygen flow to the vessel was begun after 4 minutes of monomer mixture addition. The reactor temperature was ramped to 40° C. in 18 min, maintained at 40° C. for 57 min, ramped to 45° C. in 11 min, maintained at 45° C. for 33 min and ramped to 60° C. in 10 min. 403.67 grams of monomer solution (20.3 wt. % DMP, 30.6 wt. % MPP and 49.1 wt. % toluene) was added over 35 minutes. Oxygen flow was maintained for 115 minutes, at which point the oxygen flow was stopped and the reaction mixture was immediately transferred to a vessel containing 11.07 grams NTA salt and 17.65 grams DI (deionized) water. The resulting mixture was stirred at 60° C. for 2 hours, and the layers were then allowed to separate. The decanted light phase was precipitated in methanol, filtered, reslurried in methanol, and filtered again. The copolymer was obtained as a dry powder after drying in a vacuum oven under nitrogen blanket at 110° C.

### Preparative Examples 2-4

### Preparation of MPP-DMP Copolymers with 20, 50, and 80 Mole % MPP with IV's of ˜1 Deciliter Per Gram

The process of Preparative Example 1 was scaled to a one gallon steel bubbling reactor and copolymerization was conducted in similar fashion as described above. The ingredients for the batch reactor charges and continuous monomer feed solution are shown in Table 2. After charging the reactor the contents were brought with stirring to 25° C. before starting the continuous feed of monomer in toluene and then oxygen feed. The monomer/toluene mixture was fed over 45 minutes, and oxygen feed was maintained until 130 minutes. The reactor temperature was ramped to 45° C. at 90 minutes and then ramped to 60° C. at 130 minutes. The reaction contents were then transferred to a separate vessel for addition of NTA to chelate the copper, followed by separation of the toluene solution from the aqueous phase in centrifuge, precipitation of the copolymer solution into methanol as described above.

TABLE 2
Material Amounts for Preparative Examples 2-4

| Raw Material (g) | Example 2 | Example 3 | Example 4 |
|---|---|---|---|
| MPP/DMP (mole ratio) | 20/80 | 50/50 | 80/20 |
| CAT | 17.3 | 21.6 | 17.3 |
| DBEDA | 5.3 | 6.7 | 5.3 |
| DBA | 9.9 | 9.9 | 9.9 |
| DMBA | 34.3 | 33.3 | 32.5 |
| QUAT | 1.6 | 2.0 | 1.6 |
| DMP/TOLUENE 50/50 | 29.5 | 18.5 | 5.5 |
| TOLUENE | 2961.0 | 2961.0 | 2961.0 |
| MPP | 5.6 | 14.0 | 16.0 |
| Continuous Feed Solution | | | |
| DMP/TOLUENE 50/50 | 364.5 | 228 | 64 |
| MPP | 69.4 | 172 | 197 |
| Total | 3498.36 | 3466.925 | 3310.08 |

The dried copolymers were characterized for molecular weight distribution via gel permeation chromatography (GPC) using CHCl₃ as solvent and referenced to polystyrene standards. Intrinsic viscosity (IV) was measured in CHCl₃ solution at 25° C., using an Ubbelohde viscometer, and is expressed in units of deciliters per gram (dL/g). The glass transition temperature Tg was measured using differential scanning calorimetry (DSC) and expressed in ° C. The results for examples 1-4 are summarized in Table 3. “Mn” refers to number average molecular weight, “Mw” refers to weight average molecular weight, “D” refers to polydispersity, and “g” refers to grams.

TABLE 3
Characterization of MPP-DMP Copolymers of Preparative Examples 1-4

| Ex. | | MPP/DMP | GPC Mn | GPC Mw | GPC D | IV in CHCl₃ | |
|---|---|---|---|---|---|---|---|
| No. | Scale | (mole/mole) | (g/mole) | (g/mole) | (Mw/Mn) | (dL/g) | Tg ° C. |
| 1 | 1.8 liter | 50/50 | 20,213 | 219,130 | 10.8 | 0.83 | 185 |
| 2 | 1 gallon | 20/80 | 50,310 | 172,100 | 3.4 | 1.04 | 210 |
| 3 | 1 gallon | 50/50 | 39,820 | 194,900 | 4.9 | 0.97 | 187 |
| 4 | 1 gallon | 80/20 | 22,620 | 241,000 | 10.7 | 0.96 | 177 |

### Examples 5-10

### General Procedure for Casting Membranes Via Solvent/Non-Solvent Phase Inversion Process

In general, porous, asymmetric membranes were cast by dissolving MPP-DMP copolymers in NMP at concentrations of around 16 wt. %; pouring the viscous casting solution onto a glass plate and drawing a thin film 150-250 micrometers thick across the plate by means of a casting knife. The glass plate bearing the thin film of MPP-DMP in NMP was placed into a primary coagulation bath over a time period of 10-15 minutes. The primary coagulation bath was a mixture of NMP and water, and promoted the precipitation and coagulation of the copolymer into an asymmetric porous membrane. The coagulated copolymer film floated free of the glass plate when coagulation was substantially complete, at which time it was transferred to a second bath in which it was soaked and rinsed in clean water to remove residual NMP.

The process is described in more detail as follows. The test copolymer was dissolved in N-methyl-2-pyrrolidone (NMP), chromatography grade, totaling 8-10 grams in a 20 milliliter (mL) glass vial, sealed tightly, and placed on a low speed roller for 13-48 hours until it forms a homogenous solution. The solution was poured in an oblong puddle and an adjustable height doctor blade was used to drag across the glass plate at a constant speed by hand. The entire glass plate bearing the cast copolymer solution was fully submerged into an initial non-solvent bath (25-100 wt. % DI water in NMP) until the membrane begins to lift off the plate. The membrane was transferred off of the glass plate into the intermediate non-solvent bath of 100 wt. % DI water and weighed down at the corners with glass stoppers to allow the exchange of NMP into the water bath. After 15-45 minutes the membrane was transferred to a final non-solvent bath of 100 wt. % water to fully solvent exchange the pores overnight, also weighed down to submerge fully. The membrane was dried at room temperature. Characterization was performed on pieces cut from the center and most uniform portion of the membrane. The viscosity of the copolymer solutions in NMP was measured at 20° C. using a Brookfield RDV-II Pro viscometer equipped with a small-sample adapter and cylindrical spindle.

### Characterization of Membranes

A simple estimate of the water flow through the membranes was made by cutting a 47-millimeter (mm) circle of the membrane and placing it on a fritted funnel and clamped. The vacuum filter flask was tared on a balance then 100 g of water was added to the fritted funnel and one atmosphere vacuum was applied for 15-60 min. (minutes). All data were normalized to a 60-min. run time. The water flow was calculated by placing the vacuum filter flask on the tared balance and recording the value.

The surface porosities and cross-sectional morphologies of the membranes were characterized using Carl Zeiss Supra VP scanning electron microscopy (SEM). The “top” membrane surfaces (those that were first in contact with the NMP/water bath) were imaged for selective surface morphology. The membrane samples were coated with ˜0.3 nm Pt/Pd target using Cressington 208 high resolution sputter coater equipped with thickness controller MTM-20. The surface morphology was imaged using low voltage capability (≦5 kV, probe current 200 nA and inlens surface sensitive detection mode at 100,000× magnifications. A minimum of 3 images were combined for digital image analysis using Clemex Vision PE 6.0.035 software to estimate the pore size distributions and pooled for the analysis. Samples for cross-sectional imaging were soaked in ethanol for 5 minutes and cryo-fractured using liquid nitrogen, then allowed to come to room temperature and dried in air. The cryo-fractured membrane samples were coated with Pt/Pd target and imaged using SEM for cross sectional morphology.

The interaction of the membrane surfaces with water was quantified via measurement of contact angle using a Kruss DA-25 drop shape analysis system. A small square section of membrane was cut out from the center of the membrane, and mounted on a glass microscope slide using double sided tape. A 2-microliter water droplet was deposited on the surface and the drop shape was measured using digital curve fitting 5 times with a 1 second spacing and the resulting contact angles of the water droplet with the membrane surface were averaged together.

### Example 5 and Comparative Example 1

### Membrane Cast from 50/50 MPP-DMP Copolymer Vs. Comparative Example Cast from PES/PVP

A sample of polyethersulfone (PES) having a high molecular weight, and of a grade typically used to cast hollow fiber membranes for hemodialysis was dissolved in NMP at 16 wt. % in combination with 8 wt. % of polyvinylpyrrolidone (PVP K30). In Comparative Example 1, this solution was cast into a membrane in the laboratory following the procedure described above. In Example 5, a solution of the MPP-DMP copolymer of Preparative Example 1 at 16 wt. % in NMP was prepared and cast into a membrane following the same process to prepare Example 5. The results of SEM image analysis of these two membranes are summarized in Table 4. In Table 4, “cP” refers to centipoise, “nm” refers to nanometers, “μm” refers to micrometer, “h” refers to hour, and “atm” refers to atmosphere (pressure).

TABLE 4
Membrane Properties of Example 5 vs. Comparative Example 1

| | | | Membrane Properties | | | | |
|---|---|---|---|---|---|---|---|
| | NMP Casting Dope | | Surface Pore Size | Mean Cross- | Extent of | | Contact |
| Ex. | | Viscosity | Distribution | sectional | Macrovoid | Water Flow, | Angle, |
| No. | Wt % Resin | (cP at 20° C.) | (nm) | Thickness (μm) | Formation | (g/h · atm) | Water |
| C1 | 16% PES + | 3,065 | 7.3 ± 1.9 | 128 | high | 25 | 70 |
| | 8% PVP | | | | | | |
| 5 | 16% Ex. 1 | 3,533 | 9.3 ± 3.2 | 40 | low | 39 | 82 |

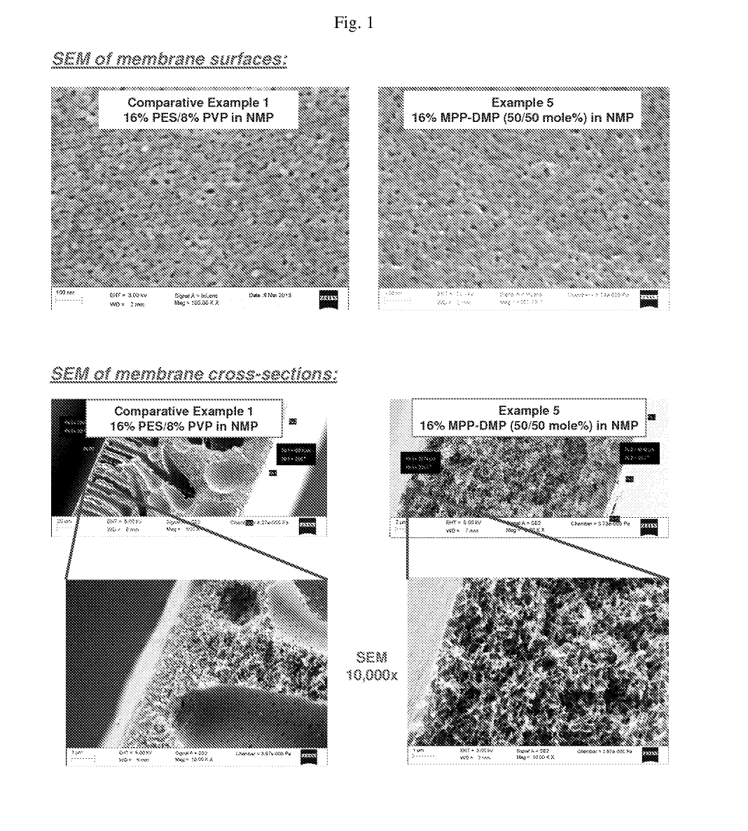

FIG. 1 depicts scanning electron microscopy (SEM) images of the porous membrane surfaces and cross-sections of Comparative Example 1 and Example 5. The images, clockwise from the upper left corner are of the surface of Comparative Example 1, the surface of Example 5, cross-sections of Example 5, and cross-sections of Comparative Example 1. These membranes were both formed in the absence of a second solvent. As can be seen from images, the surface appearance of the membrane of Example 5 compares very well to Comparative Example 1, and digital image analysis summarized in Table 4 confirms that Example 5 achieves a very similar pore size distribution as Comparative Example 1, in the absence of a pore-forming agent such as PVP. The cross-sectional morphology of Example 5 shows the formation of the desired co-continuous or “sponge” morphology to a large extent even in the absence of the PVP additive. The solution viscosity of Example 5 of our invention also compares well to that of the Comparative Example 1 which relies on addition of PVP to create a casting dope of suitable viscosity.

The water flow data indicates that the pores visible at the surface of Example 5 via SEM do indeed connect throughout the sample to allow the passage of water in a manner at least equivalent to that of Comparative Example 1, which is rather remarkable in the absence of the PVP additive. These results demonstrate that MPP-DMP copolymers of sufficiently high IV are inherently capable of forming well-structured membranes via phase-inversion casting with solvents such as NMP without requiring the use of fugitive pore-forming additives such as PVP. The contact angle of Example 5 remains higher than that of Comparative Example 1.

### Examples 6-8

### Membranes Cast from MPP-DMP Copolymers of Different Mole Ratios

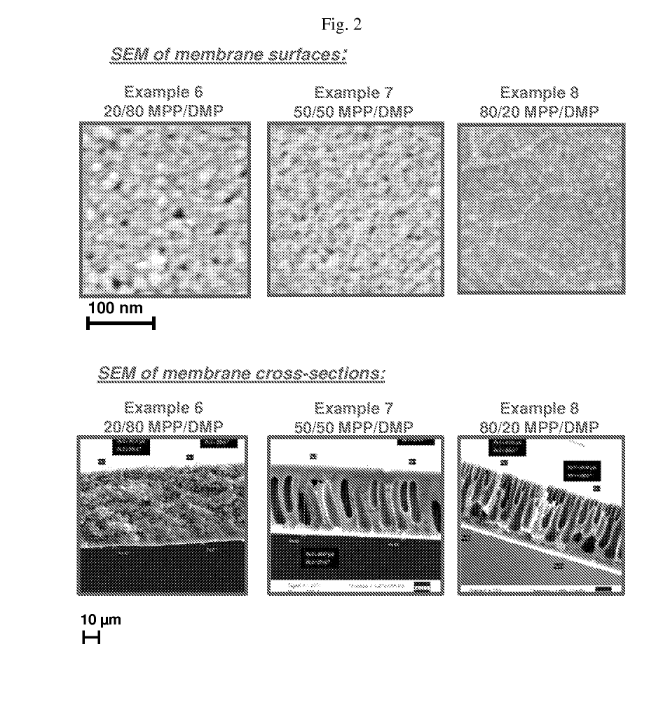

In Examples 6-8, the MPP-DMP copolymers of Examples 2-4, respectively, were dissolved at 16 wt. % in NMP and cast into membranes following same procedures as above. The results of SEM image analysis of these membranes are presented in FIG. 2, and a summary of characterization data for these membranes is provided in Table 5. There is relatively little effect on the membrane pore size distribution or contact angle to be seen by varying the MPP-DMP mole ratio over the range of 20/80 to 80/20. However, there does appear to be a trend towards greater macrovoid formation in the membrane cross-section as MPP monomer content is increased.

TABLE 5
Membrane Properties of Examples 6-8

| | | | Membrane | | | |
|---|---|---|---|---|---|---|
| | NMP Casting Dope | | Surface Pore Size | Mean Cross- | Extent of | Contact |
| Ex. | | Viscosity | Distribution | sectional | Macrovoid | Angle, |
| No. | Wt % Resin | (cP at 20° C.) | (nm) | Thickness (μm) | Formation | Water |
| 6 | 16% Ex. 2 | 8,833 | 12.2 ± 3.8 | 53 | Very low | 86 |
| 7 | 16% Ex. 3 | 3,417 | 9.9 ± 1.9 | 47 | Moderate | 77 |
| 8 | 16% Ex. 4 | 1,308 | 12.0 ± 3.5 | 47 | High | 83 |

### Preparative Examples 11-13

### Preparation of MPP-DMP Copolymers with 20, 50, and 80 Mole-% MPP in One-Gallon Reactor

MPP-DMP copolymers with 20, 50, and 80 mole % MPP were prepared in a 1-gallon reactor using the same methods as in Preparative Examples 2-4. The dried copolymers were characterized for molecular weight distribution as described above for Preparative Examples 2-4. The results for Preparative Examples 11-13 are summarized in Table 7. “Mn” refers to number average molecular weight, “Mw” refers to weight average molecular weight, “D” refers to polydispersity, and “g” refers to grams.

TABLE 7
Characterization of MPP-DMP Copolymers
of Preparative Examples 11-13

| Ex. | MPP/DMP | GPC Mn | GPC Mw | GPC D | IV in CHCl₃ |
|---|---|---|---|---|---|
| No. | (mole/mole) | (g/mole) | (g/mole) | (Mw/Mn) | (dL/g) |
| 11 | 20/80 | 63,010 | 210,800 | 3.3 | 1.14 |
| 11a | 20/80 | 49,940 | 199,700 | 4.0 | 1.08 |
| 12 | 50/50 | 42,460 | 216,200 | 5.1 | 0.98 |
| 13 | 80/20 | 36,490 | 310,700 | 8.5 | 1.08 |

### Examples 14-16

### Casting of Membranes Via Solvent/Non-Solvent Phase Inversion Process

Membranes were cast using the same procedures as described for Examples 5-10, except that the temperature was controlled to be 35° C. throughout the casting and initial phase-inversion coagulation process. The vials of copolymer solutions in NMP were equilibrated for several hours in a milled aluminum “dry block” which was controlled at 35.0±0.1° C. by use of an electric heater. The glass casting plates and casting knife were equilibrated for several hours atop an electrically-heated hot plate at 35.0±0.1° C. before use. The NMP/water coagulation solution of 2 liters was contained in a digitally-controlled thermostat bath at 35.0±0.1° C. Additionally the viscosity of the copolymer solutions in NMP was measured using a Brookfield LVDV3T viscometer equipped with a cone & plate measuring heat and circulating water bath, controlled to within 0.1° C. of the desired temperature.

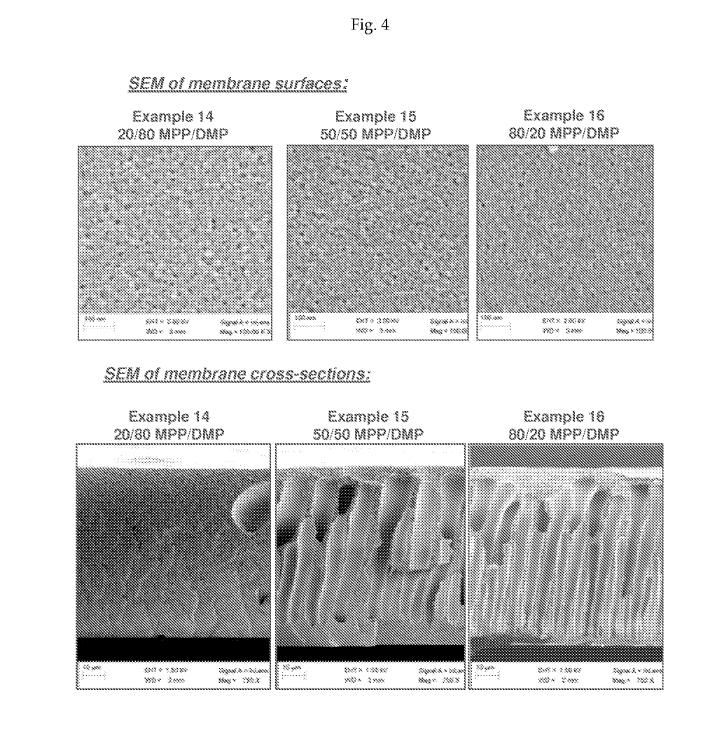

Membranes were cast at 35° C. and characterized for surface pore size distribution and cross-sectional structure by SEM, the results of which are provided in Table 8 and in FIG. 4. The solution viscosity data again shows a trend towards lower viscosity as MPP co-monomer content is increased as seen at lower temperatures in Table 4. A strong correlation between the amount of MPP co-monomer and the formation of macrovoids in the cross-section of the membranes is observed.

TABLE 8
Membranes cast from MPP-DMP copolymers
into 30/70 NMP/water at 35° C.

| | | | Membrane Properties | | |
|---|---|---|---|---|---|
| | NMP Casting Dope | | Surface | Surface | |
| | | Viscosity | Pore Size | Pore Density | Extent of |
| Ex. | Wt % | (cP at | Distribution | (pores | Macrovoid |
| No. | Resin | 35° C.) | (nm) | per μm²) | Formation |
| 14 | 16% Ex. 11 | 6,838 | 11.4 ± 3.0 | 508 | Very low |
| 15 | 16% Ex. 12 | 1,474 | 10.4 ± 2.4 | 607 | Moderate |
| 16 | 16% Ex. 13 | 909 | 9.7 ± 1.9 | 476 | high |

### Example 17 and Comparative Example 2

### Comparison of PES/PVP and 50/50 MPP-DMP Membranes

To facilitate comparison, the membrane of Example 17 was prepared using the 50/50 MPP-DMP copolymer of Example 12 and the procedure of Example 15, except that the concentration of the copolymer was increased to 18% by weight in order to better match the expected viscosity of Comparative Example 2.

The solution viscosities measured at 20° C. of Comparative Example 2 and Example 17 were similar but not quite as high as stated in Table 9 of International Application Publication WO 2013/131848. Because the membrane castings were to be conducted at 35° C., the solution viscosities were measured at that temperature and the viscosity of Example 17 was found to be significantly higher than the Comparative Example 2. Because of differences in the temperature sensitivity between a PES/PVP blend and a single MPP-PPE copolymer in NMP, no further adjustments to solution viscosity were made.

Flat membranes were cast from these solutions at 35° C. according to the procedure of Example 1 in the '848 application. The dried membranes were characterized by SEM, the results of which are shown in FIG. 2. The characteristics of the membranes are provided in Table 9. The membranes of Comparative Example 2 have a much higher degree of macrovoid formation, larger mean surface pore sizes and lower pore density than those of Example 17.

TABLE 9
Flat Membranes Cast According to the Conditions of the ′848 Application.

| | | | | Membrane | | |
|---|---|---|---|---|---|---|
| | NMP Casting Dope | | | Surface Pore Size | | Extent of |
| Ex. | | Viscosity | Viscosity | Distribution | Surface Pore Density | Macrovoid |
| No. | Wt % Resin | (cP at 20° C.) | (cP at 35° C.) | (nm) | (pores per μm²) | Formation |
| C2 | 14% 6020P/ | 5,764 | 1,858 | 11.3 ± 3.0 | 1,803 | High |
| | 5% K30/ | | | | | |
| | 2% K90/ | | | | | |
| | 3% H₂O | | | | | |
| 17 | 18% Ex. 12 | 4,386 | 3,270 | 9.9 ± 2.1 | 2200 | Moderate |

### Ex. 18-20 and Comparative Ex. 3

### Hollow Fiber Spinning Trials

The membrane-forming compositions (NMP casting dopes) of Examples 14-16, (containing the MPP-DMP copolymers of Examples 11-13, respectively) and Comparative Example 2 were processed into hollow fiber membranes according to the methods disclosed in the '848 application. ULTRASON™ 6020P (BASF) was maintained for 24 hrs. under vacuum prior to mixing to remove all moisture. The chemicals were mixed in a glass bulb until a homogenous solution was reached. Before filling the spinning solution into the spinning set up, the composition was filtered through a 25 m metal mesh to remove any residual particles in the composition. The spinning solution was degassed for 24 hrs. before the spinning. For all spinnings, a bore solution of 70 wt % deionized water and 30 wt % NMP was prepared and was degassed for 24 hrs. before use.

Hollow fiber membranes of PES and PVP (Comparative Example 3) were prepared on a laboratory scale by dry-wet immersion precipitation spinning using the apparatus shown in the schematic of FIG. 3 and under conditions adapted from the '848 application. The copolymer solution along with the bore liquid were simultaneously pumped through a double orifice spinneret and after passing the air gap, immersed into the water coagulation bath. The take-up velocity was controlled by a pulling wheel, which enabled also stretching of the fiber. A solution of MPP-DMP copolymer according to Example 12 of 18% by weight in NMP was successfully spun into hollow PPE fibers to produce Example 18 using the same apparatus and the same conditions as used to prepare Comparative Example 3.

A summary of the fiber spinning conditions, spinneret geometry, and measured dimensions of the dried hollow fibers is shown in Table 10. For Comparative Example 3, the rinsing bath was held at 65° C. according to the example in the '848 application, which is understood to be for rinsing away excess PVP from the surface of the hollow fiber membrane. For Examples 18-20, which were prepared from the 20/80, 50/50, and 80/20 MPP-PPE copolymers, respectively, the rinsing bath was held at 30° C. for safety in handling the fibers and because there is no PVP to be washed away. The take-up velocity was adjusted such that the wall thickness of the two hollow fiber samples was in the range of 40-60 micrometers. The post treatment process for the hollow fiber produced was as described in the '848 application. The fibers were washed in 70° C. purified water for 3 hrs. After 1.5 h the water was exchanged. Afterwards the fibers were rinsed for another 24 hrs. in water at tap temperature. After the rinsing step, the fibers were hung in the lab to dry in air at ambient temperature.

Based on the finding that the membrane-forming polymer solution viscosity in NMP was very sensitive to the amount of MPP co-monomer in the copolymer, the concentration of each resin was adjusted so as to yield an essentially constant solution viscosity of just over 3,000 cP. As a result there is a direct correlation between the level of MPP co-monomer in the copolymer and the mass of PPE per unit length of fiber, with Example 18a demonstrating the most efficient use of resin under the same spinning conditions. The fiber wall thickness was also maintained to a greater extent in Ex. 19, suggesting that with further optimization of fiber spinning conditions to reduce the wall thickness, a greater reduction in mass per unit length can be realized.

TABLE 10
Summary of Process Conditions for Hollow
Fiber Spinning and Fiber Properties

| | Example | | | |
|---|---|---|---|---|
| | C. Ex. 3 | | | |
| | 14% 6020P/ | Ex. 18 | Ex. 19 | Ex. 20 |
| | 5% K30/ | 18% | 14% | 20% |
| Wt % Polymer in | 2% K90/ | Ex. | Ex. | Ex. |
| NMP Casting Dope | 3% H₂O | 12 | 11 | 13 |
| Viscosity (cP at 35° C.) | | 3270 | 3091 | 3137 |
| Dope temp. [° C.] | 35 | 35 | 35 | 35 |
| Die temp. [° C.] | — | — | — | — |
| Shaft temp. [° C.] | ~22 | ~30 | ~30 | ~22 |
| Shaft humidity [%] | 50 | 60 | 60-65 | 60 |
| Room humidity [%] | 35 | 40 | 40 | 40 |
| 1^{st} bath temp. [° C.] | 30 | 30 | 30 | 30 |
| 2^{nd} bath temp. [° C.] | 65 | 30 | 30 | 30 |
| Air Gap [cm] | 100 | 100 | 100 | 100 |
| Dope extrusion rate [mL/min] | 1.56 | 1.56 | 1.56 | 1.56 |
| Bore extrusion rate [mL/min] | 3.1 | 3.1 | 3.1 | 3.1 |
| Take up velocity [m/min] | 9.12 | 7.04 | 7.07 | 7.00 |
| Spinneret dimensions | | | | |
| Inner diameter [mm] | 0.4 | 0.4 | 0.4 | 0.4 |
| Outer diameter [mm] | 1.12 | 1.12 | 1.12 | 1.12 |
| Dry hollow fiber | | | | |
| dimensions by SEM | | | | |
| Inner diameter [μm] | 445 | 605 | 510 | 605 |
| Wall thickness [μm] | 59 | 41 | 47 | 23 |
| Mass per km (g) | 25.9 | 40.2 | 31.1 | 43.3 |

### Preparation of Hollow Fiber Membrane Modules

Lab scale hollow fiber membrane modules as shown in FIG. 4 were prepared for the clean water flux and molecular weight cut off measurements. 5-10 fibers, depending on the geometry were guided through polypropylene tubes and the t-connections, which provide access to the outer surface of the hollow fibers. Both ends were sealed with hot glue. After the glue hardened, the modules were carefully cut open at one or both ends to expose the inner core of the hollow fibers to make them ready to use. The membrane length was between 25 and 30 cm. The fibers of Ex. 20 were more brittle than the other fibers, and extra care was required to glue the fibers of Ex. 20 into the modules to avoid damaging the fibers.

### Measurement of Clean Water Flux

Clean water flux (CWF) was measured as follows. A pump was connected to a mass flow controller and a pressure sensor. Behind the pressure sensor the membrane module was connected so that the filtration direction was inside-out, that is the water was forced into the bore side of the membrane and permeated through the membrane to the outside of the membrane. The filtration mode was dead end filtration, that is only one end of the filtration module was cut open and connected to the feed solution. The flow rate was set to 100 g/h and the feed pressure was recorded over time. After the pretreatment of the membrane modules, the experiment was run for 1 hr. to achieve steady state conditions.

Prior to the measurement, all the hollow fibers were wetted with a mixture of 50 wt % water and 50 wt % ethanol. Afterwards clean water was permeated through the hollow fiber membranes for 15 minutes to remove all residual ethanol from the fibers. The measurement was started directly after the pretreatment. The results of the water flux measurements are provided in Table 11.

TABLE 11
Clean Water Flux Measurements

| Ex. | Clean Water Flux (L/(h · m² · bar)) |
|---|---|
| CE3 (PES/PVP) | |
| Module 1 | 8.0 |
| Module 2 | 8.6 |
| Module 3 | 7.9 |
| Module 4 | 9.1 |
| Average | 8.4 ± 0.6 |
| E18 (E12 - 20/80 MPP-DMP) | |
| Module 1 | 44.3 |
| Module 2 | 24.9 |
| Module 3 | 64.8 |
| Module 4 | 60.1 |
| Module 5 | 54.4 |
| Average | 49.7 ± 15.8 |
| E19 (E11 -50/50 MPP-DMP) | |
| Average of 4 Modules | 40.2 ± 21 |
| E20 (E13 - 80/20 MPP-DMP) | |
| Average of 3 Modules | 133 ± 18.5 |

As can be seen from Table 11, the highest clean water flux (133 L/(h·m²·bar)) was obtained at the highest MPP comonomer content—the 80/20 MPP-DMP copolymer of Ex. 20. Without being bound by theory, this effect may be due to the thinner fiber cross-section obtained with those fibers—a wall thickness of only 23 μm, as reported in Table 10. Although the individual values vary, the clean water flux for all the PPE copolymer fibers (Ex. 18-20) are substantially higher than the C. Ex. 3 fiber, which has a clean water flux of about 8 L/(h·m²·bar), and which was taught by prior art application publication '848.

### Measurement of Molecular Weight Cut-Off

Prior to the measurement of the molecular weight cut-off (MWCO), all membrane modules were wetted with a mixture of 50 wt % water and 50 wt % ethanol. Next, clean water was permeated through the hollow fiber membranes for 15 minutes to remove all residual ethanol from the fibers. The measurement was started directly after the pretreatment.

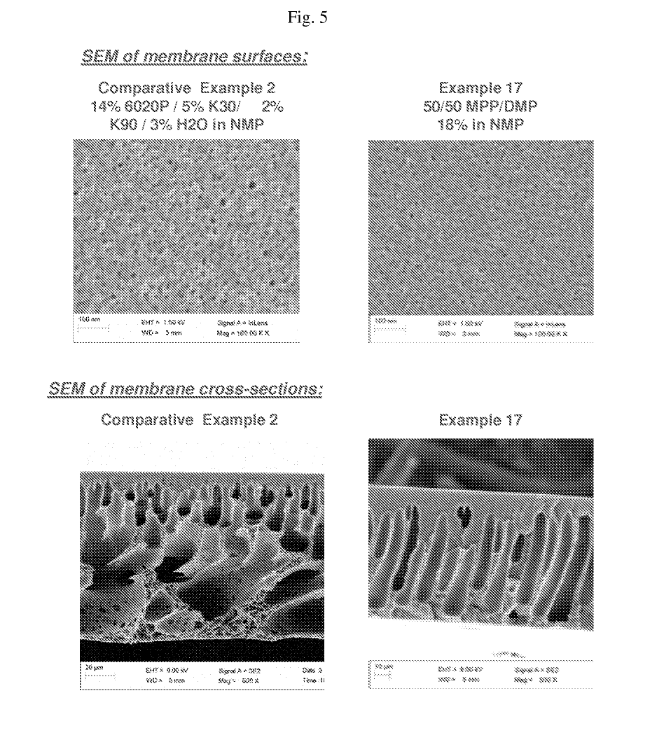

FIG. 5 shows a schematic drawing of the MWCO measurement apparatus. Both ends of the hollow fiber filtration modules shown in FIG. 5 were cut and the feed solution was pumped through the inside of the hollow fibers and the retentate recirculated to the feed tank. The permeate solution is circulated across the outside of the fibers via the T-connectors and recycled to a separate feed tank. The cross flow velocity was controlled via the pump and the feed, retentate, and pressure are recorded. The permeate pressure was at ambient pressure. A valve at the retentate side can optionally be used to control the retentate pressure.

A turbulent flow inside the hollow fiber is desirable in order to prevent concentration polarization during the experiment. To provide turbulent flow, the cross flow velocity is set to target a Reynolds number of about 3000. The Reynolds number is defined according to Equation 1, whereas “η” is defined as the dynamic viscosity of the fluid, “ρ” is defined as the density of the fluid, “v” defined as the fluid velocity and “d” defined as the inner fiber diameter.

$$Re = \frac{ρ * v * d}{η} \qquad ( Eq . 1 )$$

As a feed solution, a mixture of four different dextrans, which differ in molecular weight (1 kDa, 4 kDa, 8 kDa and 40 kDa), was used. The concentration in the feed solution was 0.5 g/L for each dextran. The molecular weight cut off is defined as that molecular weight of a species which is retained up to 90 percent by the membrane. The retention is calculated by comparing the gel permeation chromatography of the initial solution of dextrans to that measured on permeate and retentate solutions after reaching equilibrium.

Three filtration modules of each of Comparative Example 3 and Examples 18-20 were tested, and the results are summarized in Table 12. For the three PES modules of Comparative Example 3, it was possible to run the MWCO experiment under conditions of a Reynolds number (Re) of 3000. However, no MWCO was determined for two modules (Retention was always below 90 percent for the given feed.) and for the third module the MWCO was not stable over time.

In contrast to the PES/PVP hollow fibers of Comparative Example 3, the PPE copolymer hollow fibers of Examples 18-20 appeared to be defect-free under the same conditions of high Re (3,000-3,600) and high trans-membrane pressure (TMP, 1.9-3.5 bar) and yielded stable MWCO values of 6-15 kDa. Thus the membranes of Examples 18-20 provide an improved combination of higher CWF and stable low MWCO over the membrane produced from PES and PVP. In addition, the membranes of Examples 18-20 provided improved mechanical integrity. The fact that this performance can be achieved from membranes formed from inherently hydrophobic PPE resin in the absence of pore-forming additives (hydrophilic polymer), using only a simple wetting process based on aqueous ethanol, is surprising.

Stable readings were readily obtained for the additional examples: since the MWCO values at either extreme of MPP co-monomer content were essentially the same we conclude that there is no significant effect of this parameter on the ability to form well-controlled pore size distributions from the PPE during hollow fiber spinning

TABLE 12
Molecular Weight Cut-off Measurements

| | | MWCO (kDa) | | | |
|---|---|---|---|---|---|
| Hollow | | 60 | 75 | 120 | 180 |
| Fiber | Polymer | min | min | min | min |
| CE3 | CE2 | Re = 3,000; flow = 100 L/h; TMP = 2.1 bar | | | |
| | (PES/PVP) | 10.1 | — | 44.3 | 59.3 |
| | | 90 Percent retention was not reached. | | | |
| | | 90 Percent retention was not reached. | | | |
| E18 | E12 (50/50 | Re = 3,000; Flow = 140 L/h; TMP = 2.1 bar | | | |
| | MPP-DMP) | 8.3 | 7.3 | 6.3 | — |
| | | 5.2 | 6.6 | 5.3 | — |
| | | 6.4 | 5.2 | 5.2 | — |
| | | Average = 5.6 | | | |
| E19 | E11 (20/80 | Re = 3,600; Flow = 140 L/h; TMP = 1.9 bar | | | |
| | MPP-DMP) | 61.7 | 54.5 | 51.4 | — |
| | | 15.9 | 14.6 | 13.6 | — |
| | | 12.8 | 13.6 | 13.4 | — |
| | | Average = 13.5 | | | |
| E20 | E13 (80/20 | Re = 3,250; Flow = 150 L/h; TMP = 3.5 bar | | | |
| | MPP-DMP) | 16.3 | — | 16.1 | 15.6 |
| | | 14.0 | — | 13.5 | 17.5 |
| | | 17.7 | — | 19.5 | 13.2 |

Average = 15.4

### Summary of Hollow Fiber Spinning

The results of the hollow fiber spinning trials (Examples 18-20) illustrate that MPP-DMP copolymers that incorporate the minimum amount of MPP co-monomer required for solubility in solvents such as NMP, for example the 20/80 MPP-DMP copolymer of Example 11, also result in the maximum increase in solution viscosity for a given concentration of copolymer. The results also show that PPE copolymers having much less than 50 mole % MPP comonomer provide an advantageous reduction in the mass of resin per unit length of hollow fiber, for example, 31.1 km/g for the hollow fibers of Example 19 fabricated from 20/80 MPP-DMP copolymer of Example 11. The hollow fibers of Examples 18-20 show that MPP-DMP copolymers having a weight average molecular weight of 150,000 to 400,000 daltons and a broad molecular weight distribution, with polydispersity values of 3 to 9, provide high-quality hollow fibers. The polymerization process for these copolymers can be scaled up for industrial production. Moreover, weight-average molecular weight of these copolymers can be varied to optimize dope solution viscosity, and surface pore size and distribution.

### SEM Comparison of Hollow Morphology

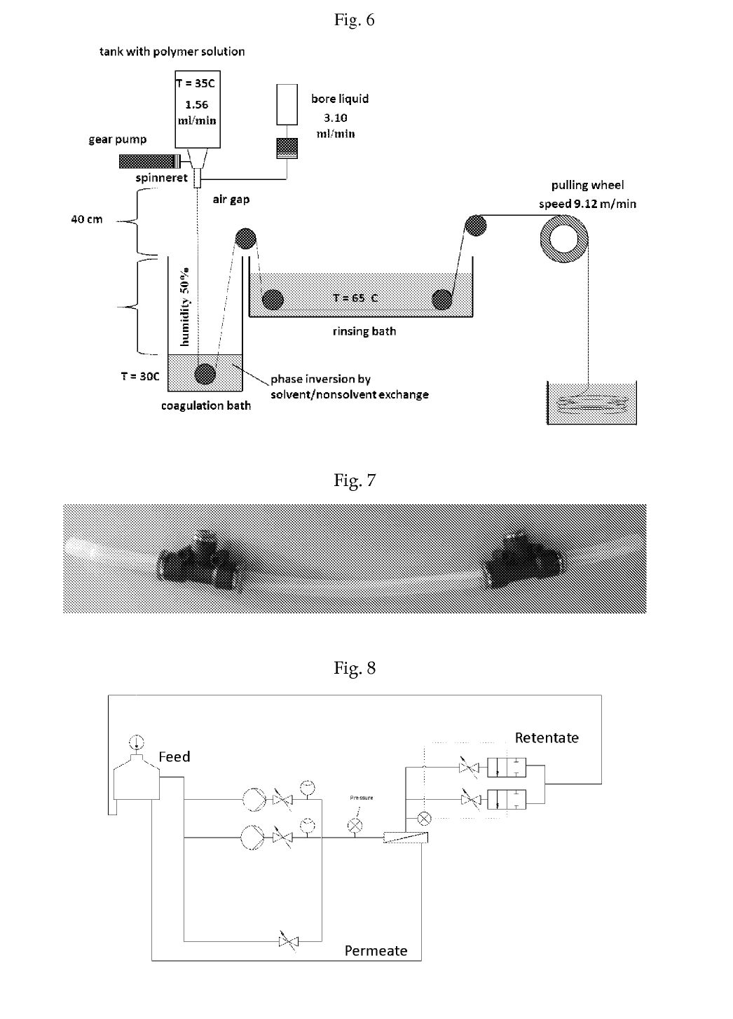

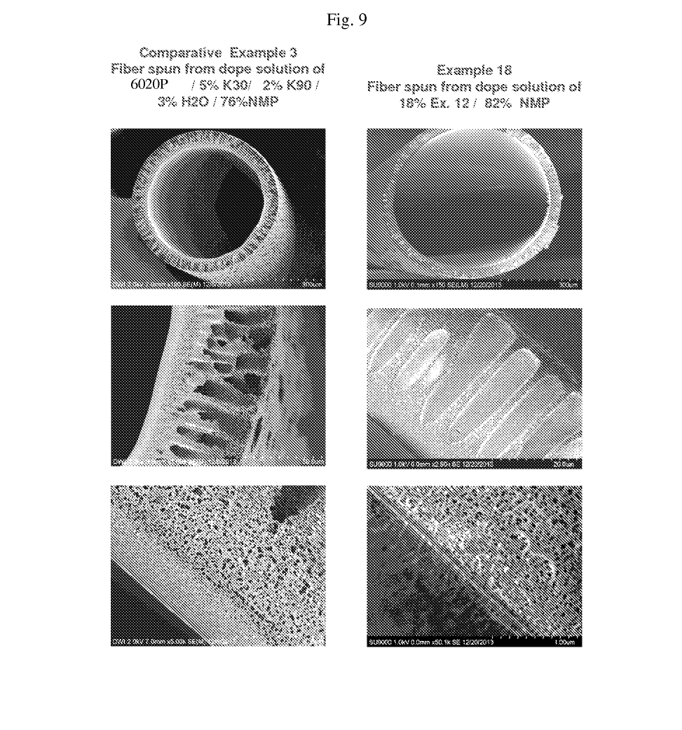

Samples of the two batches of hollow fiber membranes were analyzed by SEM, the results of which are shown in FIG. 6. The membranes of Comparative Example 3, prepared from PES and PVP, show a strongly asymmetric cross-sectional morphology, and similar to those obtained for flat membrane castings of the same dope composition (FIG. 2). The dense selective layer appears to be thin for the PES/PVP comparative example in both the flat and the hollow fiber geometry. In comparison, the morphology of the PPE hollow fiber of Example 18 shows a dense, spongy morphology that persists across the hollow fiber cross-section, which is also consistent with the appearance of the flat membranes produced from the same dope composition (FIG. 2). Thus the high-IV PPE co-polymers disclosed herein provide inherently superior membrane-forming characteristics which can be realized in either flat or hollow fiber geometries.

### Effect of Glycerin as a Pore Stabilizer.

Ultrafiltration membranes produced from PES and PVP with small surface pores can suffer “pore collapse” during drying unless treated with a pore-stabilizing additive such as glycerin. This stabilizing treatment adds cost to the membrane production process, and further can cause users of the membranes to extensively rinse them with water or ethanol-water in order to remove the pore-stabilizing additives prior to use. After observing the relatively poor performance of the composition of Comparative Example 3 using the prescribed fiber-spinning conditions the effect of using glycerin prior to drying was evaluated to see if this treatment would have beneficial effect on the comparative example PES/PVP membrane or on the PPE copolymer fiber membrane.

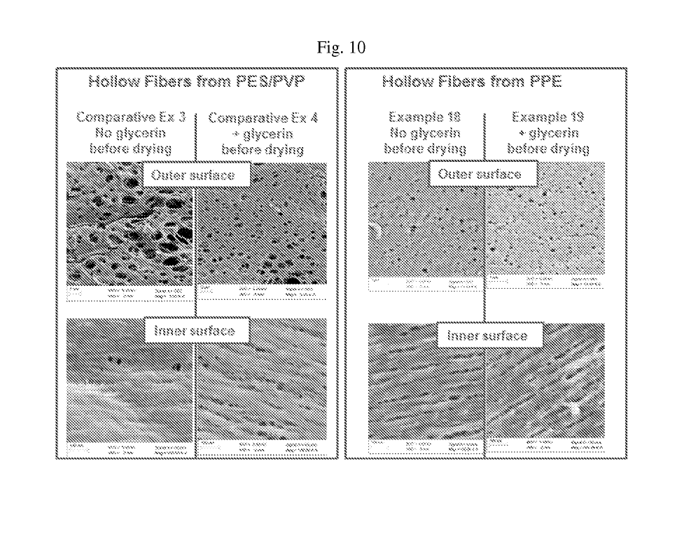

A portion of the wet as-spun fibers of Comparative Example 3 and Example 18 were immersed in a mixture of 80 wt % water/20 wt % glycerol for 24 hours prior to the drying step to create Comparative Example 4 and Example 19, respectively. The morphology of the two pairs of fibers were studied in more detail by SEM after carefully cutting open the fibers so that the inner selective surface layer could be examined. In FIG. 10 the images from PES fibers dried as-spun or with glycerin are shown on the left side of the FIG. 10, and those from PPE fibers dried as-spun or with glycerin are shown on the right side of FIG. 10. The use of glycerin post-treatment results in a dramatic increase in the presence of nanometer-size pores on the inner selective surface of fibers prepared from PES. The inner surface of Comparative Example 3 is almost featureless unless the glycerin stabilization treatment is used, which, while not wanting to be bound by theory, may explain the low CWF measurements. In contrast to Comparative Example 3, the inner surface of the Example 18 hollow fibers shows relatively abundant pores of nanometer size, and the appearance is essentially unaffected by the use of glycerin as treatment prior to drying.

The observed phenomena of pore collapse in the hollow fiber spinning of Comparative Example 3 made from PES/PVP demonstrates that the hollow fiber-spinning process for preparation of nanoporous membranes from this combination of polymers is not inherently robust and that processing adjustments and post-stabilization with additives are necessary to obtain useable porous membranes. The MPP-PPE copolymers exhibit excellent membrane-forming characteristics, readily translate from flat to hollow fiber geometry, form stable pores of suitable size and density without post-treatment with additives such as glycerin, and produce economically attractive combinations of water flux and MWCO values, which represent significant and unexpected improvements over porous membranes made from other materials.

The MPP-DMP copolymers of high intrinsic viscosity, which are soluble in solvents such as NMP, may also be useful in the fabrication of composite membranes, i.e. capable of modification by the application of one or more layers of another polymeric material for purposes of modifying the permeability or selectivity of the composite membrane. The MPP-DMP copolymers of high instrinsic viscosity, are suitable for other fiber-forming processes, for example direct spinning of solid nanofibers from solution. The resulting nanofibers can be used to form various non-woven filtration media including separators for lithium ion batteries.

The use of the terms “a” and “an” and “the” and similar referents in the context of describing the invention (especially in the context of the following claims) is to be construed to cover both the singular and the plural, unless otherwise indicated herein or clearly contradicted by context. “Or” means “and/or.” The endpoints of all ranges directed to the same component or property are inclusive and independently combinable. Disclosure of a narrower range or more specific group in addition to a broader range is not a disclaimer of the broader range or larger group. All ranges disclosed herein are inclusive of the endpoints, and the endpoints are independently combinable with each other. The terms “first” and “second” and the like, as used herein do not denote any order, quantity, or importance, but are only used to distinguish one element from another. The term “comprises” as used herein is understood to encompass embodiments consisting essentially of, or consisting of, the named elements.

Unless defined otherwise, technical and scientific terms used herein have the same meaning as is commonly understood by one of skill in the art to which this invention belongs. A “combination” is inclusive of blends, mixtures, alloys, reaction products, and the like.

As used herein, the term “hydrocarbyl” refers broadly to a moiety having an open valence, comprising carbon and hydrogen, optionally with 1 to 3 heteroatoms, for example, oxygen, nitrogen, halogen, silicon, sulfur, or a combination thereof. Unless indicated otherwise, the hydrocarbyl group can be unsubstituted or substituted, provided that the substitution does not significantly adversely affect synthesis, stability, or use of the compound. The term “substituted” as used herein means that at least one hydrogen on a hydrocarbyl group is replaced with another group (substituent) that contains a heteroatom selected from nitrogen, oxygen, sulfur, halogen, silicon, or a combination thereof, provided that the normal valence of any atom is not exceeded. For example, when the substituent is oxo (i.e. “═O”), then two hydrogens on a designated atom are replaced by the oxo group. Combinations of substituents and/or variables are permissible provided that the substitutions do not significantly adversely affect the synthesis, stability or use of the compound.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A porous membrane, wherein the porous membrane comprises a poly(phenylene ether) copolymer, wherein the porous membrane has at least one of a molecular weight cut off of less than 40 kilodaltons and a surface pore size of 0.001 to 0.1 micrometers.

2. The porous membrane of claim 1, wherein the poly(phenylene ether) copolymer comprises first and second repeat units having the structure: 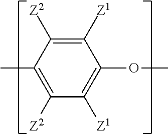
wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy, wherein at least two carbon atoms separate the halogen and oxygen atoms,
wherein each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy, wherein at least two carbon atoms separate the halogen and oxygen atoms, and
wherein the first repeat units and second repeat units are not the same.

3. The porous membrane of claim 1, wherein the poly(phenylene ether) copolymer comprises:
99 to 20 mole percent repeat units derived from 2,6-dimethylphenol; and
1 to 80 mole percent repeat units derived from a second monohydric phenol having the structure 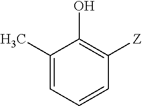
wherein Z is C₁-C₁₂ alkyl or cycloalkyl, or a monovalent radical having the structure 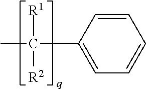
wherein q is 0 or 1, and R¹ and R² are independently hydrogen or C₁-C₆ alkyl;
wherein all mole percents are based on the total moles of all repeat units.

4. The porous membrane of claim 3, wherein the copolymer comprises:
80 to 20 mole percent repeat units derived from 2,6-dimethylphenol; and
20 to 80 mole percent repeat units derived from the second monohydric phenol.

5. The porous membrane of claim 4, wherein the second monohydric phenol is 2-methyl-6-phenylphenol.

6. The porous membrane of claim 1, wherein the poly(phenylene ether) copolymer has an intrinsic viscosity of 0.7 to 1.5 deciliters per gram, when measured in chloroform at 25° C.

7. The porous membrane of claim 1, wherein the poly(phenylene ether) copolymer has a weight average molecular weight of 100,000 to 500,000 daltons, as measured in chloroform by gel permeation chromatography against polystyrene standards.

8. The porous membrane of claim 1, wherein the poly(phenylene ether) copolymer has a solubility of 50 to 400 grams per kilogram in N-methyl-2-pyrrolidone at 25° C. in, based on the combined weight of the poly(phenylene ether) copolymer and N-methyl-2-pyrrolidone.

9. The porous membrane of claim 1, comprising 20 to 99 weight percent of the poly(phenylene ether) copolymer and 1 to 80 weight percent of poly(2, 6-dimethyl-1,4-phenylene ether), polyethersulfone, polysulfone, polyphenylsulfone, or a combination comprising at least one of the foregoing, based on the total weight of the porous membrane.

10. A porous membrane-forming composition for making the porous membrane of claim 1, comprising:
a poly(phenylene ether) copolymer comprising the first and second repeat units; and
a water-miscible polar aprotic solvent, wherein the poly(phenylene ether) copolymer is dissolved in the water-miscible polar aprotic solvent.

11. A method of making the porous membrane of claim 1, comprising:
dissolving the poly(phenylene ether) copolymer in a water-miscible polar aprotic solvent to form a porous membrane-forming composition; and
phase-inverting the porous asymmetric membrane forming-composition in a first non-solvent composition to form the porous membrane.

12. The method of claim 11, wherein hydrophilic and amphiphilic polymers are absent from the membrane-forming composition and the first non-solvent composition.

13. The method of claim 11, further comprising washing the porous membrane in a second non-solvent composition.

14. The method of claim 11, further comprising drying the porous membrane.

15. A porous membrane made by the method of claim 11.

16. A method of making a hollow fiber by coextrusion through a spinneret comprising an annulus and a bore, wherein the method comprises coextruding:
a membrane-forming composition comprising a poly(phenylene ether) copolymer, dissolved in a water-miscible polar aprotic solvent through the annulus, and
a first non-solvent composition comprising water, a water-miscible polar aprotic solvent, or a combination comprising at least one of the foregoing, through the bore,
into a second non-solvent composition comprising water, a water-miscible polar aprotic solvent, or a combination comprising at least one of the foregoing, to form the hollow fiber.

17. The method of claim 16, wherein hydrophilic and amphiphilic polymers are absent from the membrane-forming composition and the first non-solvent composition.

18. A separation module comprising the porous membrane of claim 1.

19. A hollow fiber made by the method of claim 16.

20. A separation module comprising the hollow fiber of claim 19.
